(19) United States
(12) Patent Application Publication
(10) Pub. No.: US 2010/0278472 A1
(43) Pub. Date: Nov. 4, 2010

(54) ROLLER BEARING RETAINER, NEEDLE ROLLER BEARING, AND PRODUCTION METHOD OF ROLLER BEARING RETAINER

(76) Inventors: Shinji Oishi, Shizuoka (JP); Katsufumi Abe, Shizuoka (JP); Yugo Yoshimura, Shizuoka (JP)

Correspondence Address: CLARK & BRODY, 1700 Diagonal Road, Suite 510, Alexandria, VA, 22314, US

(21) Appl. No.: 12/810,627

(22) PCT Filed: Dec. 2, 2008
(86) PCT No.: PCT/JP2008/071863

§ 371 Date: Jun. 25, 2010

(30) Foreign Application Priority Data
Dec. 27, 2007 (JP) 2007-336939

(51) Int. Cl. F16C 33/46; B21D 53/12

(52) U.S. Cl. 384/572; 29/898.067

(57) ABSTRACT

A roller bearing retainer 33 includes a plurality of column parts 15 each containing a column center part 16, a pair of column end parts 17, and a pair of column sloped parts 18 positioned between the column center part 16 and each of the pair of column end parts 17, and a pair of annular ring parts 14 connected to longitudinal one side and the other side ends of the plurality of column parts 15, and having a flange part 19 extending from a position connected to the column part 15 toward the radial inner side. Thus, the column center part 16, the pair of column end parts 17, and the pair of column sloped parts 18 are formed by expanding both axial ends of a cylindrical member, and the flange part 19 is formed by compressing the cylindrical member in an axial direction, and at the same time a thickness of a boundary part between adjacent two parts of the column center part 16, the pair of column end parts 17, the pair of column sloped parts 18, the flange part 19, and the pair of ring parts 14 is made larger than a thickness of each part of the column center part 16, the pair of column end parts 17, the pair of column sloped parts 18, the flange part 19, and the pair of ring parts 14.

### TECHNICAL FIELD

The present invention relates to a roller bearing retainer produced by a press process, a needle roller bearing provided with the roller bearing retainer, and a production method of the roller bearing retainer.

### BACKGROUND ART

A cage & roller type needle roller bearing composed of rollers and a retainer is used in an idler bearing for a car transmission, and a con-rod big-end bearing for an engine of a motorbike in many cases. Such bearing is disclosed in Japanese Unexamined Patent Publication No. 2000-257638.

According to the document, it is disclosed that an annular member having an M-shaped section is formed by performing bulging work on a pipe-shaped material, and a window for holding a roller is formed in the annular member, so that a lightweight roller bearing retainer with a large load capacity can be provided.

When the roller bearing retainer is formed by the method disclosed in the above document, a bended part, that is, a boundary part between a column center part and a column sloped part, a boundary part between the column sloped part and a column end part, and a boundary part between the column end part and an annular part become thinner than a thickness of the pipe-shaped material. Since a stress applied to the retainer during the bearing rotation is concentrated on the bended part, when the bended part is thinned, the roller bearing retainer is likely to be damaged.

### DISCLOSURE OF THE INVENTION

It is an object of the present invention to provide a roller bearing retainer having a strengthened bended part, a needle roller bearing provided with such roller bearing retainer, and a production method of such roller bearing retainer.

A roller bearing retainer according to the present invention includes a plurality of column parts each containing a column center part positioned in an axial center region on a radial inner side comparatively, a pair of column end parts positioned in axial end regions on a radial outer side comparatively, and a pair of column sloped parts positioned between the column center part and each of the pair of column end parts, and a pair of annular ring parts connected to longitudinal one side and the other side ends of the plurality of column parts, and having a flange part extending from a position connected to the column part toward the radial inner side. Thus, the column center part, the pair of column end parts, and the pair of column sloped parts are formed by expanding both axial ends of a cylindrical member having a diameter equal to that of the column center part substantially, and the flange part is formed by compressing the cylindrical member in an axial direction, and at the same time a thickness of a boundary part between adjacent two parts of the column center part, the pair of column end parts, the pair of column sloped parts, the flange part, and the pair of ring parts is made larger than a thickness of each part of the column center part, the pair of column end parts, the pair of column sloped parts, the flange part, and the pair of ring parts.

Thus, the strength of the boundary part is comparatively improved. As a result, the retainer can be prevented from being damaged due to the stress concentration. In addition, since the flange part is formed and the boundary part is thickened at the same time, the processes for the retainer can be simplified. As a result, the retainer can be provided at low cost. In addition, the term “thickness” in this specification designates a thickness dimension between the inner diameter surface and the outer diameter surface as for the column center part, the column end part, the column sloped part and the ring part, and designates a thickness dimension in the axial direction as for the flange part. In addition, the term “boundary part between adjacent two parts of the column center part, the pair of column end parts, the pair of column sloped parts, the flange part, and the pair of ring parts” designates a boundary part between the adjacent parts extending in different directions. In other words, it designates a boundary part between the column center part and each of the pair of column sloped parts, a boundary part between each of the pair of column end parts and each of the pair of column sloped parts, and a boundary part between the ring part and the flange part.

According to one embodiment, the flange part is formed by bending both axial ends of the cylindrical member toward the radial inner side at a predetermined angle and then further bending it in a direction perpendicular to the axial direction.

Preferably, the retainer has a plurality of pockets formed in a circumferential surface of the cylindrical member by a blanking process, and a roller stopper part formed on a wall surface of the column part opposed to the pocket by an ironing process. Thus, the roller can be appropriately prevented from escaping from the retainer.

Preferably, the thickness of each part of the column center part, the pair of column end parts, the pair of column sloped parts, the flange part, and the pair of ring parts is larger than a curvature radius of the boundary part between adjacent two parts of the column center part, the pair of column end parts, the pair of column sloped parts, the flange part, and the pair of ring parts. Thus, a surface area of the part being in contact with the peripheral members can be increased. As a result, a contact surface pressure can be reduced, and abrasion and burning can be prevented.

According to another aspect of the present invention, a needle roller bearing includes a plurality of needle rollers, and any one of the above roller bearing retainers in which the pocket to house the roller is formed between the adjacent column parts. The needle roller bearing can be highly reliable by using the above roller bearing retainer.

According to still another aspect of the present invention, a production method of a roller bearing retainer is a method for producing a roller bearing retainer including a plurality of column parts each containing a column center part positioned in an axial center region on a radial inner side comparatively, a pair of column end parts positioned in axial end regions on a radial outer side comparatively, and a pair of column sloped parts positioned between the column center part and each of the pair of column end parts, and a pair of annular ring parts connected to longitudinal one side and the other side ends of the plurality of column parts, and having a flange part extending from a position connected to the column part toward the radial inner side. The production method of the roller bearing retainer includes a step of forming the column center part, the pair of column end parts, and the pair of column sloped parts by expanding both axial ends of a cylindrical member having a diameter equal to that of the column center part substantially, and a step of forming the flange part by compressing the cylindrical member in an axial direction, and at the same time making a thickness of a boundary part between adjacent two parts of the column center part, the pair of column end parts, the pair of column sloped parts, the flange part, and the pair of ring parts larger than a thickness of each part of the column center part, the pair of column end parts, the pair of column sloped parts, the flange part, and the pair of ring parts.

Thus, according to the retainer, the strength of the boundary part is comparatively improved. As a result, the retainer can be prevented from being damaged due to the stress concentration. In addition, since the flange part is formed and the boundary part can be thickened at the same time, the processes for the retainer can be simplified. As a result, the retainer can be produced at low cost.

Consequently, according to the roller bearing retainer in the present invention, the roller bearing retainer can be highly strengthened by thickening the boundary part as compared with the other parts. In addition, since the flange part is formed and the boundary part can be thickened at the same time, the processes for the retainer can be simplified. As a result, the retainer can be produced at low cost.

In addition, according to the needle roller bearing in the present invention, its reliability is enhanced by using the above roller bearing retainer.

In addition, according to the production method of the retainer in the present invention, the retainer having the comparatively strengthened boundary part can be produced. As a result, the retainer can be prevented from being damaged due to the stress concentration. In addition, since the flange part is formed and the boundary part can be thickened at the same time, the processes for the retainer can be simplified. As a result, the retainer can be produced at low cost.

### BRIEF DESCRIPTION OF DRAWINGS

FIG. 1 is a perspective view showing a roller bearing retainer according to one embodiment of the present invention;

FIG. 2 is a perspective view showing a needle roller bearing having the roller bearing retainer shown in FIG. 1;

FIG. 3 is a perspective view showing a structure of a pocket of the roller bearing retainer shown in FIG. 1;

FIG. 4 is a view taken from an arrow IV in FIG. 3;

FIG. 5 is a view showing a variation of the roller bearing retainer shown in FIG. 1 and corresponds to FIG. 4;

FIG. 6 is a flowchart showing main production processes of the roller bearing retainer shown in FIG. 1;

FIG. 7 is a view showing a deep drawing process;

FIG. 8 is a view showing a blanking process;

FIG. 9 is a view showing a burring process;

FIG. 10 is a view showing a trimming process;

FIG. 11 is a view showing a state before an expansion press process;

FIG. 12 is a view showing an expansion pressing outer die taken from an axial direction;

FIG. 13 is a view showing a state in the middle of the expansion press process;

FIG. 14 is a view showing a state after the expansion press process;

FIG. 15 is a view showing a previous process;

FIG. 16 is a view showing a bending inner die taken from an axial direction; and

FIG. 17 is a view showing a subsequent process.

### BEST MODE FOR CARRYING OUT THE INVENTION

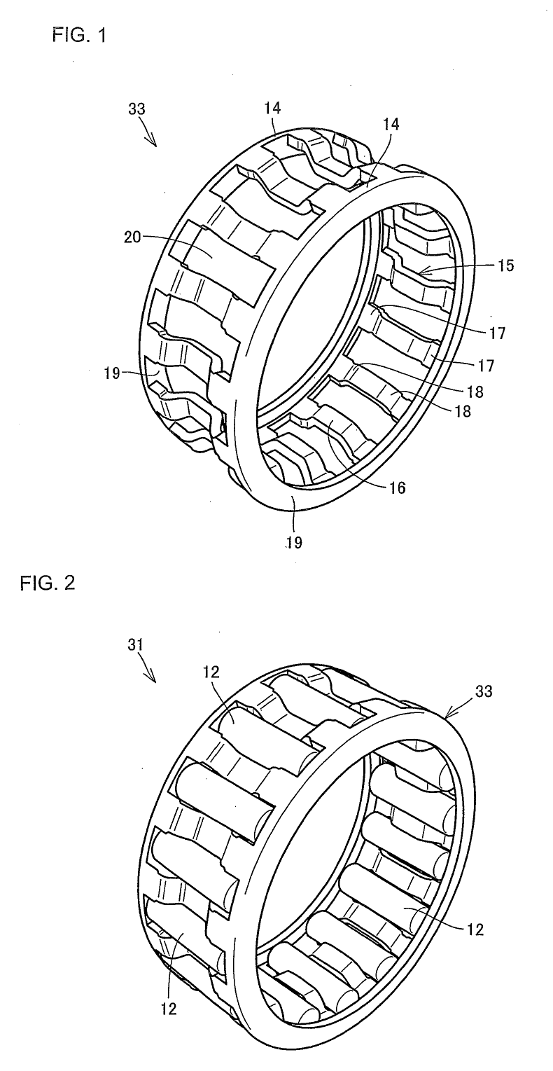

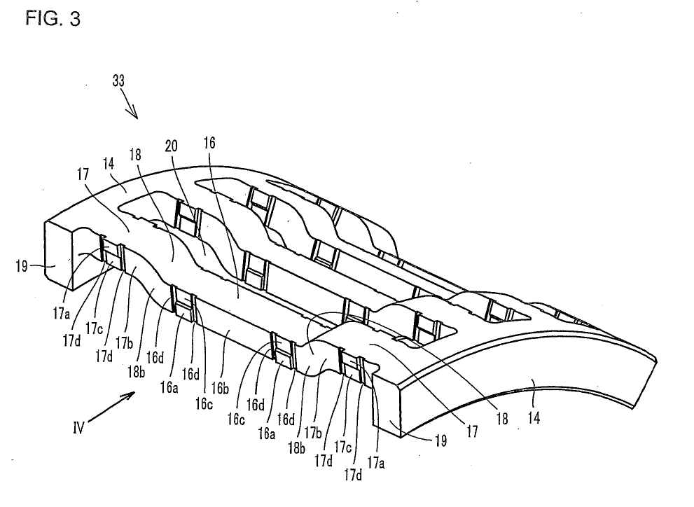

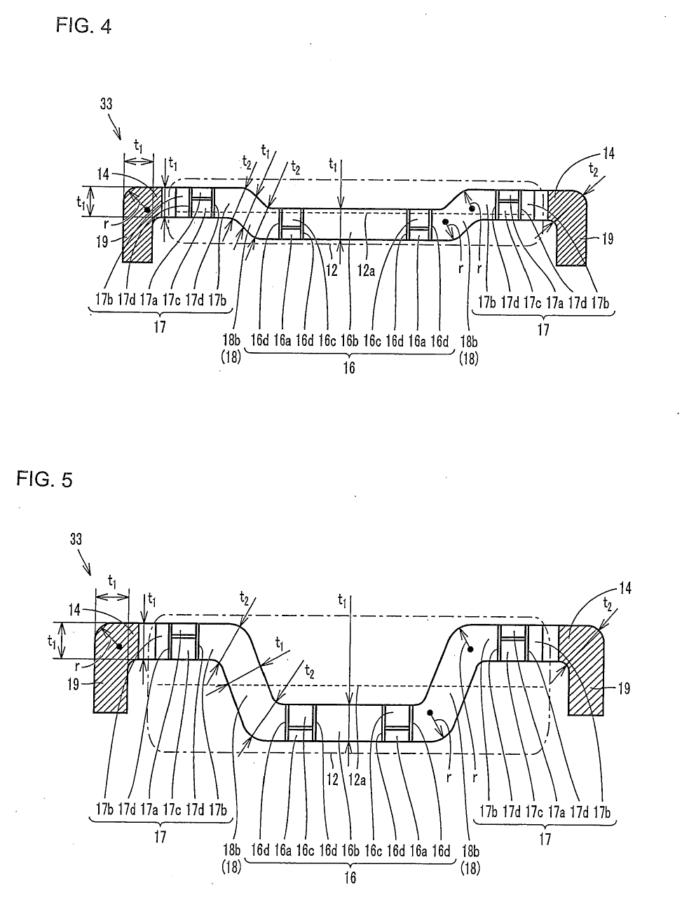

With reference to FIGS. 1 to 4, a description will be made of a needle roller bearing 31 and a roller bearing retainer 33 (referred to as “retainer 33” simply hereinafter) according to one embodiment of the present invention. In addition, FIG. 1 is a perspective view showing the retainer 33, FIG. 2 is a perspective view showing the needle roller bearing 31, FIG. 3 is a perspective view showing a configuration of a column part 15 of the retainer 33, and FIG. 4 is a view taken from an arrow IV in FIG. 3.

First, with reference to FIG. 2, the needle roller bearing 31 includes a plurality of needle rollers 12, and the retainer 33 to retain the plurality of needle rollers 12. Next, with reference to FIG. 1, the retainer 33 includes a pair of annular ring parts 14 and the plurality of column parts 15. The pair of ring parts 14 is connected to longitudinal one ends and the other ends of the column parts 15, and has a flange part 19 extending from a position connected to the column part 15, to a radial inner side. In addition, a pocket 20 to house the needle roller 12 is formed between the adjacent column parts 15.

In addition, the “annular ring part” in this specification designates only an seamless ring part continued in a circumferential direction. That is, it is to be noted that a ring part whose both ends are welded is not included.

The column part 15 includes a column center part 16 positioned in its axial center region on the radial inner side comparatively, a pair of column end parts 17 positioned in its axial end regions on the radial outer side comparatively, and a pair of column sloped parts 18 positioned between the column center part 16 and each of the pair of column end parts 17.

With reference to FIGS. 3 and 4, a wall surface of the column part 15 opposed to the pocket 20 is provided with first and second roller stopper parts 16a and 17a to prevent the needle roller 12 from escaping, guide surfaces 16b, 17b, and 18b to guide the rotation of the needle roller 12, non-contact parts 16c and 17c, and oil grooves 16d and 17d.

The first roller stopper parts 16a are provided at two points in the column center part 16. More specifically, they are located on the radial inner side of the wall surface of the column center part 16 opposed to the pocket 20. Thus, the needle roller 12 can be prevented from escaping to the radial inner side.

The second roller stopper parts 17a is provided in each of the pair of column end parts 17. More specifically, they are located on the radial outer side of the wall surfaces of the column end parts 17 opposed to the pocket 20. Thus, the needle roller 12 can be prevented from escaping to the radial outer side.

The guide surface 16b is provided in a region adjacent to the first roller stopper parts 16a in the column center part 16 in an axial direction. The guide surface 17b is provided in a region adjacent to the second roller stopper part 17a in the column end part 17 in the axial direction. The guide surface 18b is provided in a whole region of the column sloped part 18. In addition, the guide surfaces 16b, 17b, and 18b are provided in the same plane.

In addition, the non-contact parts 16c and 17c that are retreated from the guide surfaces 16b and 17b so as not to be in contact with the needle roller 12 are provided in a region on the radial outer side of the first roller stopper part 16a and in a region on the radial inner side of the second roller stopper part 17a, respectively. These regions function as oil reservoirs. Furthermore, the oil grooves 16d and 17d extending in a radial direction are provided on both axial sides of the first roller stopper part 16a and the second roller stopper part 17a, respectively. Thus, oil flow properties of the retainer 33 in the radial direction can be improved.

According to the above column part 15, thicknesses of the column center part 16, the column end part 17, the column sloped part 18, and the ring part 14, and the flange part 19 (referred to as the “straight part” collectively hereinafter) are set to be equal to a thickness t₁ substantially. Meanwhile, a thickness t₂ of a boundary part between the column center part 16 and the column sloped part 18, a boundary part between the column end part 17 and the column sloped part 18, and a boundary part between the ring part 14 and the flange part 19 (referred to as the “boundary part” collectively hereinafter) is thicker than the thickness t₁ in the straight part (t₁<t₂). Thus, the strength of the boundary part can be comparatively improved. As a result, even when a stress is concentrated on the boundary part during the rotation of the bearing, the retainer 33 can be effectively prevented from being damaged.

In addition, a relation between the thickness t₁ of the straight part and a curvature radius r of the boundary part satisfies that r<t₁. When the curvature radius r of the boundary part is set small, the axial length of the straight part adjacent to the boundary part can be long, that is, a surface area of the straight part can be large. As a result, a contact pressure at the time of bearing rotation can be reduced.

More specifically, when the retainer 33 is guided on an outer diameter side (housing guide), an outer diameter surface of the column end part 17 and a housing (not shown) are in contact with each other. Thus, when the curvature radius r of at least the boundary part between the column end part 17 and the column sloped part 18 and the boundary part between the ring part 14 and the flange part 19 are set in the above range, the contact surface pressure between the outer diameter surface of the column end part 17 and the housing can be reduced.

In addition, surface roughness Ra of the outer diameter surfaces of the ring part 14 and the column end part 17 is set from 0.05 μm to 0.3 μm. Thus, abrasion due to the contact between the outer diameter surfaces of the ring part 14 and the column end part 17 and the housing can be prevented. In addition, the “surface roughness Ra” means arithmetic average roughness.

Meanwhile, when the retainer 33 is guided on the inner diameter side (rotation shaft guide), an inner diameter surface of the column center part 16 and a rotation shaft (not shown) are in contact with each other. Thus, when the curvature radius r of at least the boundary part between the column center part 16 and the column sloped part 18 is set in the above range, the contact surface pressure between the inner diameter surface of the column center part 16 and the rotation shaft can be reduced. In addition, in this case, surface roughness Ra of the inner diameter surface of the column center part 16 is set from 0.05 μm to 0.3 μm.

In addition, in the boundary part, an R part is formed on each side of a projection side (to which a tensile stress is applied at the time of bending process) and a recess side (to which a compressive stress is applied at the time of bending process). In this case, a curvature radius of the projection side is always larger than that of the recess side. Thus, the “curvature radius r of the boundary part” in this specification designates the curvature radius on the projection side. In addition, the “thickness t₂ of the boundary part” designates the length of a line connecting a center part of the projection side and a center part of the recess side.

In addition, an outer diameter surface of the column center part 16 is positioned on the radial outer side with respect to an inner diameter surface of the column end part 17. Thus, a pitch circle 12a of the needle roller 12 is positioned on the radial inner side with respect to the outer diameter surface of the column center part 16, and on the radial outer side with respect to the inner diameter surface of the column end part 17. Thus, the needle roller 12 is in contact with each of the guide surfaces 16b, 17b, and 18b. Thus, since a contact area between the needle roller 12 and the guide surfaces 16b, 17b, and 18b is increased, the needle roller 12 can be effectively prevented from skewing.

Here, it is to be noted that the positional relation between the column center part 16 and the column end part 17 is not limited to the above case. With reference to FIG. 5, a variation of the retainer 33 will be described. In addition, FIG. 5 is a view showing the variation of the retainer 33, and it corresponds to FIG. 4. In addition, since the configuration and function of each component are the same, the same reference is allotted to the same component as that in FIG. 4, and its description will be omitted.

With reference to FIG. 5, an outer diameter surface of the column center part 16 is positioned on the radial inner side with respect to an inner diameter surface of the column end part 17. Thus, the pitch circle 12a of the needle roller 12 is positioned on the radial outer side with respect to the outer diameter surface of the column center part 16, and on the radial inner side with respect to the inner diameter surface of the column end part 17. In this case, the needle roller 12 is guided only by the guide surface 18b of the column sloped part 18. According to this constitution, since the first roller stopper 16a and the second roller stopper 17a are arranged apart from each other in the radial direction, the needle roller 12 can be appropriately prevented from escaping.

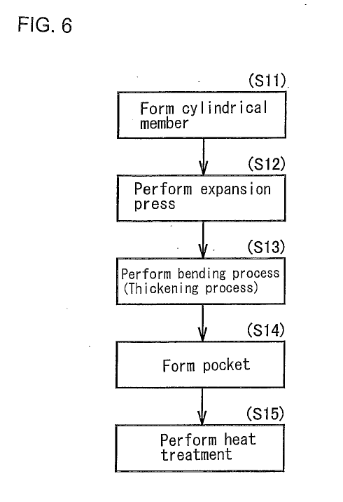

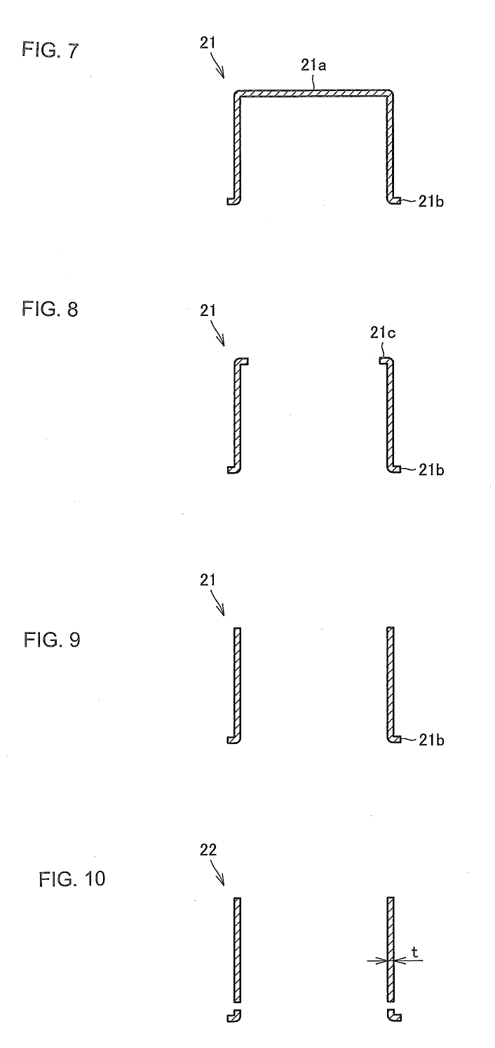

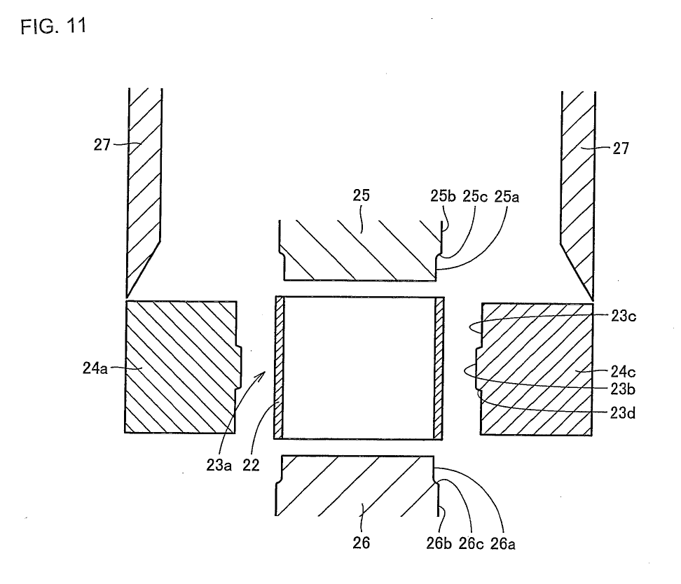

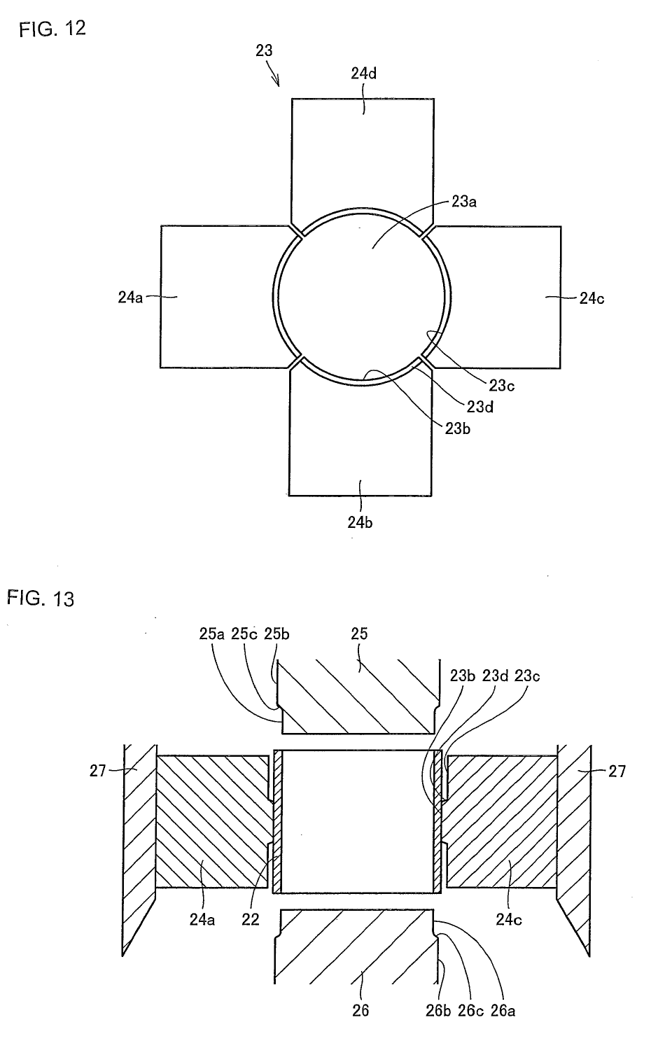

Next, with reference to FIGS. 6 to 17, a production method of the retainer 33 will be described. In addition, FIG. 6 is a flowchart showing main production processes of the retainer 33, FIGS. 7 to 10 are views showing a first process in detail, FIGS. 11 to 14 are views showing a second process in detail, and FIGS. 15 to 17 are views showing a third process in detail.

First, a steel plate (carbon steel) containing from 0.15 wt % to 1.1 wt % of carbon is used as a starting material of the retainer 33. More specifically, SCM415(JIS) and S50C(JIS) containing from 0.15 wt % to 0.5 wt % of carbon or SAE1070 and SK5(JIS) containing from 0.5 wt % to 1.1 wt % of carbon are used.

In addition, according to carbon steel containing less than 0.15 wt % of carbon, since a carburized hardened layer is not likely to be formed by a quenching process, it is necessary to perform a nitrocarburizing process to provide hardness required for the retainer 33. According to the nitrocarburizing process, since its plant cost is high as compared with the quenching process as will be described below, the production cost of the needle roller bearing 31 is increased as a result. In addition, according to carbon steel containing less than 0.15 wt % of carbon, a satisfactory carburized hardened layer cannot be provided even by the nitrocarburizing process in some cases, so that a surface-originated flake could be generated in an early stage. Meanwhile, according to carbon steel containing more than 1.1 wt % of carbon, processability is considerably lowered.

In the first process shown in FIG. 6, a cylindrical member 22 is obtained from the steel plate as the above starting material (S11). More specifically, with reference to FIG. 7, a cup-shape member 21 is obtained from the steel plate by a deep drawing process. At this time, a bottom wall 21a is formed at axial one side end of the cup-shaped member 21 (upper side of FIG. 7), and an outward flange part 21b is formed at the axial other side end thereof (lower side of FIG. 7). In addition, at this time, the surface roughness Ra on the outer diameter surface or the inner diameter surface of the cup-shape member 21 is made to be from 0.05 μm to 0.3 μm by an ironing process.

Next, with reference to FIG. 8, the bottom wall 21a of the cup-shaped member 21 is removed by a blanking process. Here, it is to be noted that the bottom wall 21a cannot be completely removed by the blanking process, and an inward flange part 21c is formed on the axial one side end of the cup-shape member 21.

Next, with reference to FIG. 9, the inward flange part 21c is processed by a burring process to be straight in the axial direction.

Furthermore, with reference to FIG. 10, the outward flange part 21b is removed by cutting the axial other side end of the cup-shaped member 21 by a trimming process.

Thus, a cylindrical member 22 is provided. An outer diameter of the cylindrical member 22 provided through the above-described processes is the same as an outer diameter of the column center part 16. In addition, now a thickness of the cylindrical member 22 provided through the above-described processes is regarded as “t”.

Next, according to the second process shown in FIG. 6, the column center part 16, the pair of column end parts 17 and the pair of column sloped parts 18 are formed by an expansion press (S12). According to the expansion press, the diameter of both axial ends of the cylindrical member 22 is expanded by an expansion pressing outer die 23 (referred to as “outer die 23” simply hereinafter) to retain the outer diameter surface of the cylindrical member 22, and a pair of expansion pressing inner dies 25 and 26 (referred to as the “inner dies 25 and 26” simply hereinafter) to retain the inner diameter surface of the cylindrical member 22.

With reference to FIGS. 11 to 14, the outer die 23 is composed of first to fourth outer die segments 24a, 24b, 24c, and 24d whose inner diameter surfaces define a cylindrical space 23a to receive the cylindrical member 22. The inner diameter surface made by the combined outer die segments 24a to 24d is composed of a small-diameter part 23b having the same diameter as the outer diameter of the column center part 16, a large-diameter part 23c having the same diameter as the outer diameter of the column end part 17, and a sloped part 23d positioning between the small-diameter part 23b and the large-diameter part 23c and having the same sloped angle as the column sloped part 18.

The first inner die 25 is a cylinder-shaped member to be inserted from the axial one side end (upper side of FIG. 11) of the cylindrical member 22. The first inner die 25 is composed of a small-diameter part 25a having the same diameter as the inner diameter of the column center part 16, a large-diameter part 25b having the same diameter as the inner diameter of the column end part 17, and a sloped part 25c positioning between the small-diameter part 25a and the large-diameter part 25b and having the same sloped angle as the column sloped part 18. The second inner die 26 has the same constitution and is inserted from the axial other side end (lower side of FIG. 11) of the cylindrical member 22.

The outer die 23 is composed of first to fourth outer die segments 24a to 24d divided radially at the angle of 90°, for example. Each of the first to fourth outer die segments 24a to 24d can be moved in the radial direction of the cylindrical member 22 by a mobile jig 27. In addition, the first and second inner dies 25 and 26 can be moved in the axial direction of the cylindrical member 22.

With reference to FIG. 11, when the first to fourth outer die segments 24a to 24d are moved backward in the radial direction, and the first and second inner dies 25 and 26 are moved backward in the axial direction, the cylindrical member 22 can be put in and taken out of the cylindrical space 23a. Here, the term “moved backward” designates that the dies are moved away from the cylindrical member 22.

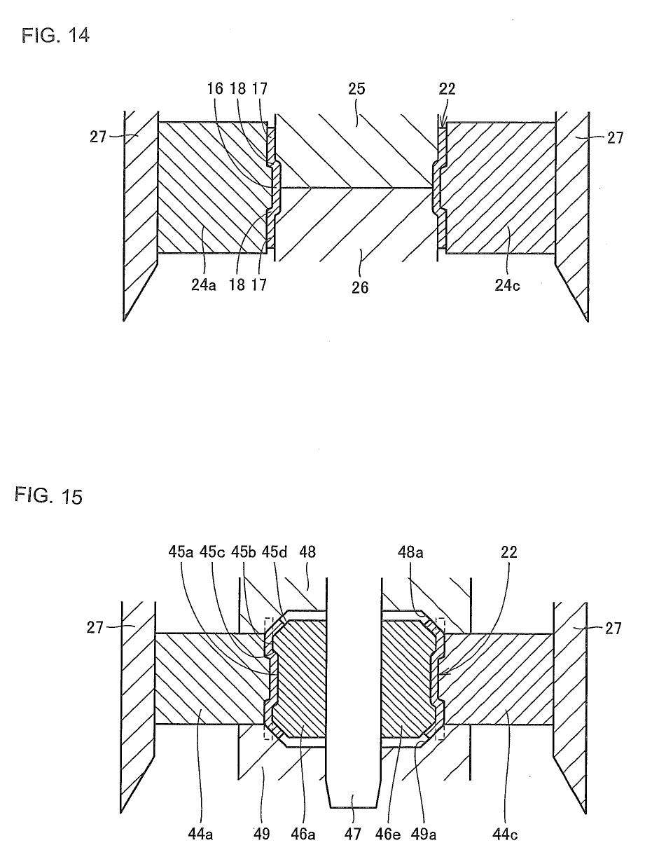

Next, with reference to FIG. 13, the first to fourth outer die segments 24a to 24d are moved forward in the radial direction until the outer diameter surface of the cylindrical member 22 is retained by the small-diameter part 23b. In addition, with reference to FIG. 14, when the first and second inner dies 25 and 26 are moved forward in the axial direction, both axial ends of the cylindrical member 22 are expanded to the radial outer side by the large-diameter parts 25b and 26b and the sloped parts 25c and 26c. Here, the term “moved forward” designates that the dies are moved toward the cylindrical member 22.

Thus, the column center part 16, the pair of column end parts 17, and the pair of column sloped parts 18 are formed. In addition, since the cylindrical member 22 is expanded by the expansion press, the thickness t₁ of the column center part 16, the pair of column end parts 17, and the pair of column sloped parts 18 after the second process is thinner than the thickness t of the cylindrical member 22 (t₁<t).

Next, according to the third process shown in FIG. 6, the flange part 19 is formed and the boundary part is thickened by a thickening process (bending process, S13). More specifically, the flange part 19 is formed through two stages of a previous process and a subsequent process. Here, the thickening process and the subsequent process are performed at the same time.

With reference to FIG. 15, the previous process is a process to bend inward both axial ends of the cylindrical member 22 to form the flange part 19 at a predetermined angle (45° in this embodiment) with respect to the column end part 17, by a bending outer die 43 (referred to as the “outer die 43” simply hereinafter), a bending inner die 45 (referred to as the “inner die 45”simply hereinafter), and a pair of bending jigs 48 and 49.

The outer die 43 has the same constitution as that of the expansion pressing outer die 23 to retain the outer diameter surface of the cylindrical member 22. Here, it is to be noted that its axial length is shorter than that of the expansion pressing outer die 23, so that both axial ends of the cylindrical member 22 to become the flange part 19 are not retained.

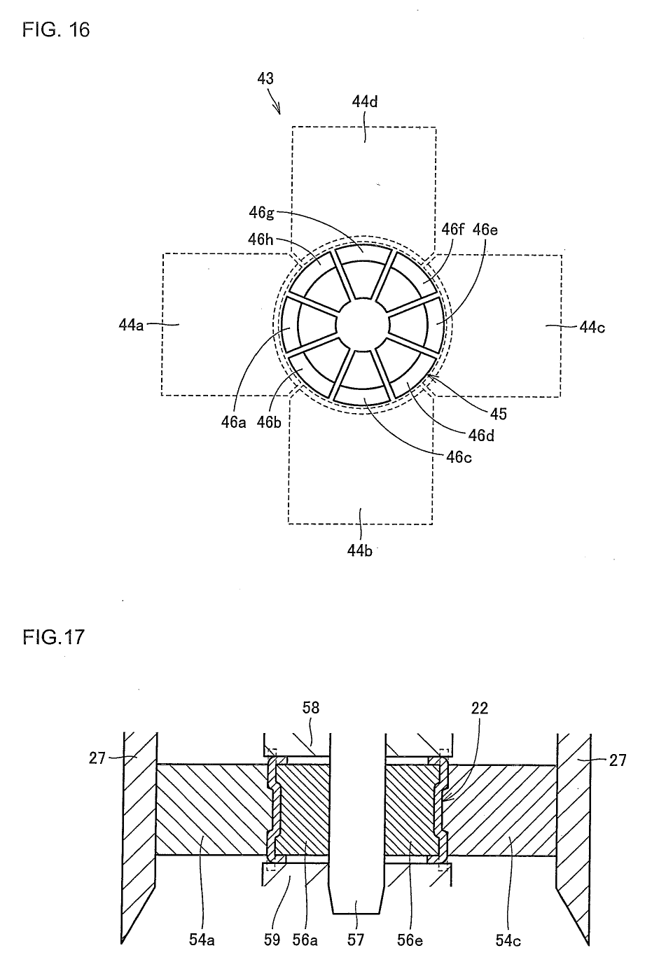

With reference to FIGS. 15 to 16, the inner die 45 is composed of first to eighth inner die segments 46a, 46b, 46c, 46d, 46e, 46f, 46g and 46h. The inner die 45 is a cylinder-shaped member made by the combined inner die segments 46a to 46h. An outer diameter surface of the inner die 45 includes small-diameter part 45a that is provided in an axial center region on the outer diameter surface and having the same diameter as the inner diameter of the column center part 16, a large-diameter part 45b that is provided in an axial end region and having the same diameter as the inner diameter of the column end part 17, and a sloped part 45c that is provided between the small-diameter part 45a and the large-diameter part 45b and follows the column sloped part 18, and bending part 45d that is provided at a corner part of each axial end to define a bending angle (45°) of flange part 19 in the previous process.

With reference to FIG. 16, the inner die 45 is composed of first to eighth inner die segments 46a to 46h divided radially at an angle of 45°. Each of the first to eighth inner die segments 46a to 46h can be moved in the radial direction.

More specifically, when the first to eighth inner die segments 46a to 46h are moved backward in the radial direction, the first to eighth inner die segments 46a to 46h can be put in and taken out of the cylindrical member 22. Meanwhile, when the first to eighth inner die segments 46a to 46h are moved forward in the radial direction, the inner diameter surface of the cylindrical member 22 is retained (state shown in FIG. 15). In addition, the inner die segments 46a to 46h can be moved forward by inserting an insertion jig 47.

The bending jig 48 has a bending part 48a following the sloped angle (45°) of the flange part 19 in the previous process, at its end, and it can be moved in the axial direction of the cylindrical member 22. The bending jig 49 has the same constitution. Thus, when the pair of bending jigs 48 and 49 are moved backward in the axial direction, the cylindrical member 22 can be put in and taken out of the cylindrical space. Meanwhile, when the pair of bending jigs 48 and 49 are moved forward in the axial direction, both axial ends of the cylindrical member 22 (parts shown by broken lines in FIG. 15) can be bent inward at the predetermined angle (45°).

Then, with reference to FIG. 17, in the subsequent process, the flange part 19 is bent at an angle of 90° with respect to the column end part 17, that is, in the perpendicular direction to the axial direction. The process jigs used in the subsequent process are bending outer die segments 54a to 54d (only 54a and 54c are shown), bending inner die segments 56a to 56h (only 56a and 56e are shown), an insertion jig 57, and a pair of bending jigs 58 and 59 having almost the same constitution used in the previous process. However, it is to be noted that the bending part is not provided in the bending inner die segments 56a to 56h and the pair of bending jigs 58 and 59 at a part opposed to the flange part 19.

According to the subsequent process, the inner and outer diameter surface of the cylindrical member 22 are retained by the same way as the previous process, and the flange part 19 is compressed from the axial direction by the bending jigs 58 and 59. Thus, the angle formed between the column end part 17 and the flange part 19 becomes 90°.

In addition, at this time, since the inner and outer diameter surface of the straight part is retained by the bending outer die segments 54a to 54d and the bending inner die segments 56a to 56h, the thickness is not changed. Meanwhile, a small gap is formed between the boundary part, and the bending outer die segments 54a to 54d and the bending inner die segments 56a to 56h. Thus, as the axial dimension of the cylindrical member 22 is reduced, the boundary part is thickened. Thus, the thickness t₂ of the boundary part after the subsequent process is thicker than the thickness t of the cylindrical member 22 obtained through the first process (t₁<t<t₂). Thus, the strength is improved not by increasing the thickness of the whole column part 15 but by decreasing the thickness of the straight part and selectively increasing the thickness of the boundary part on which the stress is concentrated. Therefore, the retainer 33 can be light in weight. In addition, at this time, the curvature radius r of the boundary part becomes smaller than the thickness t₁ of the straight part at the same time.

Next, according to a fourth process shown in FIG. 6, the pockets 20 and the oil grooves 16d and 17d are formed (S14). More specifically, the rectangular pockets 20 and the oil groove 16d and 17d are formed in the circumferential surface of the cylindrical member 22 by the blanking process. Then, each of the first and second roller stopper parts 16a and 17a, the guide surfaces 16b, 17b, and 18b, and non-contact parts 16c and 17c is formed by the ironing process.

Then, according to a fifth process shown in FIG. 6, a heat treatment is performed to give predetermined mechanical properties such as the surface hardness to the retainer 33 (S15). For the heat treatment, an appropriate method has to be selected based on the carbon contents of the starting material in order that the retainer 33 has a sufficiently deep hardened layer. More specifically, in the case of the material containing from 0.15 wt % to 0.5 wt % of carbon, a carburizing quenching process is to be performed, and in the case of the material containing from 0.5 wt % to 1.1 wt % of carbon, a bright quenching process or a high-frequency quenching process is to be performed.

The carburizing quenching process is a heat treatment method using a phenomenon in which carbon is soluble in high-temperature steel, so that a surface layer having a large amount of carbon (carburized hardened layer) can be formed while the amount of carbon is small inside. Thus, properties in which the surface is hard and the inside is soft and high in toughness can be provided. In addition, its plant cost is inexpensive as compared with the plant for the nitrocarburizing process.

According to the bright quenching process, the quenching process is performed by heating up the material in a protective atmosphere or vacuum while preventing the steel surface being oxidized. In addition, its plant cost is inexpensive as compared with the nitrocarburizing process and the carburizing process.

According to the high-frequency quenching process, the steel surface is heated up at high speed by use of a principle of induction heating and cooled down immediately to provide a hardened layer. Its plant cost is considerably low as compared with the other quenching process plants, and since gas is not used in the heat treatment, it has a merit of being environment friendly. In addition, the process has an advantage that the quenching process can be partially performed.

Furthermore, it is desirable to perform a tempering treatment after the above quenching process in order to reduce residual stress and internal distortion generated in the quenching process and to improve the toughness and stabilize the dimension.

The retainer 33 can be produced through the above processes. In addition, the surface roughness Ra of the outer diameter surface of the retainer 33 has been already from 0.04 μm to 0.3 μm in the ironing process when the cylindrical member 22 is formed (S11). Therefore, it is not necessary to perform a grinding process as a finishing process separately.

In addition, in the bending process (S13) shown in FIGS. 15 to 17, the flange part 19 is formed and the boundary part is thickened at the same time. Therefore, the processes for the retainer 33 can be simplified and the retainer 33 can be provided at low cost.

In addition, although the retainer 33 is produced from a steel plate (flat plate) as the starting material in the above embodiment, as another example, a cylindrical member such as a pipe material may be used as the starting material. In this case, the first step (S11) shown in FIG. 6 can be omitted.

In addition, although the flange part 19 is formed by bending both axial ends of the cylindrical member at the angle of 45° first and then bending at the angle of 90° in twice in the above embodiment, it may be bent at the angle of 90° at one time.

In addition, although the column center part 16, the pair of column end parts 17 and the pair of column sloped parts 18 are formed in the cylindrical member 22 by use of the dies such as the outer die 23 and the inner dies 25 and 26 in the above embodiment, they may be formed by another method, by expanding the cylindrical member 22 from its inside, for example.

In addition, a cage & roller type of needle roller bearing 31 is illustrated in the above embodiment, the present invention can be applied to a needle roller bearing having an inner ring and/or an outer ring additionally. In addition, although the needle roller 12 is used as a rolling elements in the above, a cylindrical roller or a long roller may be used.

Furthermore, when the needle roller bearing 31 according to the above embodiment is used in an idler bearing for a car transmission, and a con-rod big-end bearing for an engine of a motorbike, especially advantageous effect can be achieved.

Although the embodiments of the present invention have been described with reference to the drawings in the above, the present invention is not limited to the above-illustrated embodiments. Various kinds of modifications and variations may be added to the illustrated embodiments within the same or equal scope of the present invention.

### INDUSTRIAL APPLICABILITY

The present invention can be advantageously applied to the roller bearing retainer, the needle roller bearing, and the production method of the roller bearing retainer.

What is claimed is:

1. A roller bearing retainer comprising:
a plurality of column parts each containing a column center part positioned in an axial center region on a radial inner side comparatively, a pair of column end parts positioned in axial end regions on a radial outer side comparatively, and a pair of column sloped parts positioned between said column center part and each of said pair of column end parts; and
a pair of annular ring parts connected to longitudinal one side and the other side ends of the plurality of column parts, and having a flange part extending from a position connected to said column part toward the radial inner side, wherein
said column center part, said pair of column end parts, and said pair of column sloped parts are formed by expanding both axial ends of a cylindrical member having a diameter equal to that of said column center part substantially, and
said flange part is formed by compressing said cylindrical member in an axial direction, and at the same time a thickness of a boundary part between adjacent two parts of said column center part, said pair of column end parts, said pair of column sloped parts, said flange part, and said pair of ring parts is made larger than a thickness of each part of said column center part, said pair of column end parts, said pair of column sloped parts, said flange part, and said pair of ring parts.

2. The roller bearing retainer according to claim 1, wherein
said flange part is formed by bending both axial ends of said cylindrical member toward the radial inner side at a predetermined angle and then further bending it in a direction perpendicular to the axial direction.

3. The roller bearing retainer according to claim 1, wherein
said retainer has a plurality of pockets formed in a circumferential surface of said cylindrical member by a blanking process; and
a roller stopper part formed on a wall surface of said column part opposed to said pocket by an ironing process.

4. The roller bearing retainer according to claim 1, wherein
the thickness of each part of said column center part, said pair of column end parts, said pair of column sloped parts, said flange part, and said pair of ring parts is larger than a curvature radius of the boundary part between adjacent two parts of said column center part, said pair of column end parts, said pair of column sloped parts, said flange part, and said pair of ring parts.

5. A needle roller bearing comprising;
a plurality of needle rollers; and
the roller bearing retainer according to claim 1, in which the pocket to house said roller is formed between said adjacent column parts.

6. A production method of a roller bearing retainer comprising a plurality of column parts each containing a column center part positioned in an axial center region on a radial inner side comparatively, a pair of column end parts positioned in axial end regions on a radial outer side comparatively, and a pair of column sloped parts positioned between said column center part and each of said pair of column end parts, and a pair of annular ring parts connected to longitudinal one side and the other side ends of the plurality of column parts, and having a flange part extending from a position connected to said column part toward the radial inner side, comprising;
a step of forming said column center part, said pair of column end parts, and said pair of column sloped parts by expanding both axial ends of a cylindrical member having a diameter equal to that of said column center part substantially; and
a step of forming said flange part by compressing said cylindrical member in an axial direction, and at the same time making a thickness of a boundary part between adjacent two parts of said column center part, said pair of column end parts, said pair of column sloped parts, said flange part, and said pair of ring parts larger than a thickness of each part of said column center part, said pair of column end parts, said pair of column sloped parts, said flange part, and said pair of ring parts.
